(19) United States
(12) Patent Application Publication
(10) Pub. No.: US 2003/0152661 A1
(43) Pub. Date: Aug. 14, 2003

(54) Apparatus for extracting an injection-molding product and a system comprising such apparatus

(75) Inventors: Young Hee Yu, Incheon (KR); Sang-Hoon Park, Geumcheon-Gu (KR)

Correspondence Address: MERCHANT & GOULD PC, P.O. BOX 2903, MINNEAPOLIS, MN, 55402-0903, US

(73) Assignee: Yudo-star Co., Ltd., Incheon (KR)

(21) Appl. No.: 10/208,629

(22) Filed: Jul. 29, 2002

(30) Foreign Application Priority Data
Feb. 8, 2002 (KR) 2002-0007538

(51) Int. Cl. B29C 45/42

(52) U.S. Cl. 425/436 RM; 425/556

(57) ABSTRACT

An apparatus for extracting an injection-molding product from an injection-molding machine, which makes it possible to reduce the time required to extract the injection-molding product and is safe, comprises: a support frame; a drive installed through the support frame for generating rotation; a first arm connected to the drive and pivotable according to the rotation of the drive; a first pulley fixedly installed to the support frame to be inserted into an end of the first arm; a second pulley connected to the first pulley via a transmission belt and rotatably coupled to the other end of the first arm; and a second arm connected to the second pulley and pivotable opposite to the pivotal direction of the first arm when the first arm pivots. In addition, a system for extracting an injection-molding product having such apparatus further comprises a conveyor and a roll-over machine.

### BACKGROUND OF THE INVENTION

1. Technical Field

The invention relates to an apparatus for extracting an injection-molding product and a system comprising such apparatus, and more specifically, to an apparatus for extracting an injection-molding product and a system comprising such apparatus, which makes it possible to reduce the time required to extract the injection-molding product and is safe.

2. Description of the Prior Art

In general, an apparatus for extracting an injection-molding product is used to take out a product which is injection-molded within an injection-molding machine therefrom.

FIG. 8 is an operational perspective view illustrating a prior art system for extracting an injection-molding product.

As shown in FIG. 8, the prior art system for extracting an injection-molding product comprises an operating device 100, a drive (not shown), and a conveyor 200.

The operating device 100 is driven by the drive to take an injection-molding product A from an injection-molding machine 300 to the conveyor 200, and comprises a first arm 120, a second arm 140 and a third arm 160.

In this system, the first arm 120, the second arm 140 and the third arm 160 each moves along Y-axis, X-axis and Z-axis, respectively, to take the injection-molding product A from the injection-molding machine 300 to the conveyor 200.

However, in such a system for extracting an injection-molding product, a prolonged time is required to extract and transfer the product. And the mechanism is complicated in structure, since the first, second and third arms 120, 140 and 160 of the operating device 100 each moves along three different axes of Y, X and Z, respectively.

In addition, as the operating device 100 is mounted on the injection-molding machine 300 and the third arm 160 moves along the Z-axis, it is impossible for the system to be used in the factories which do not have enough space in height.

Yet, among other prior art systems for extracting an injection-molding product, there is a system for extracting injection-molding product with the above-mentioned problems improved.

FIG. 9 is an operational view of another prior art system for extracting an injection-molding product.

As shown in FIG. 9, the system comprises an operating device 100, a drive (not shown), and a conveyor 200.

In this prior art system, the operating device 100 comprises a first arm 120, a second arm 140, and a base 180.

In this system, the first arm 120 and the second arm 140 each moves along Y-axis and X-axis, respectively, to take the injection-molding product A from the injection-molding machine 300 to the conveyor 200.

As a result, this system can reduce the time required to take the injection-molding product from the injection-molding machine to the conveyor, in comparison with the conventional system of FIG. 8, and it is possible for the system to be used in the factories which have relatively small space in height because the operating device 100 is driven in horizontal linear movement.

However, a large horizontal working space is required for such a system for extracting an injection-molding product, due to the long stroke of the first arm 120.

Furthermore, a worker or an operator might be injured inadvertently by the extended long first arm 120 during the transfer of the injection-molding product A to the conveyor 200.

### BRIEF SUMMARY OF THE INVENTION

Therefore, the present invention is designed to address such problems as described above, and it is an object of the invention to provide an apparatus for extracting an injection-molding product and a system comprising such apparatus, with less time required for extracting the injection-molding product than that of the prior art system.

It is another object of the invention to provide an apparatus for extracting an injection-molding product and a system comprising such apparatus, which is simple, inexpensive and safe.

In order to accomplish the above objects, an apparatus for extracting an injection-molding product of the invention comprises: a support frame; a drive installed through the support frame for generating rotation; a first arm connected to the drive and pivotable according to the rotation of the drive; a first pulley fixedly installed to the support frame to be inserted into one end of the first arm; a second pulley connected to the first pulley via a transmission belt and rotatably coupled to the other end of the first arm ; and a second arm connected to the second pulley and pivotable opposite to the pivotal direction of the first arm when the first arm pivots.

The ratio of the diameter of the first pulley to that of the second pulley is 2:1, and the first arm further comprises a tension idle roller installed thereon for maintaining a constant tension in the transmission belt.

An end of the second arm is provided with a suction plate for extracting an injection-molding product from an injection-molding machine through vacuum suction.

A system for extracting an injection-molding product of the invention comprises: an apparatus for extracting an injection-molding product comprising a drive installed through a support frame for generating rotation, a first arm connected to the drive and pivotable according to the rotation of the drive, a first pulley fixedly installed to the support frame to be inserted into one end of the first arm, a second pulley connected to the first pulley via a transmission belt and rotatably coupled to the other end of the first arm, a second arm connected to the second pulley and pivotable opposite to the pivotal direction of the first arm when the first arm pivots, and a suction plate installed at an end of the second arm for extracting an injection-molding product from an injection-molding machine; a conveyor installed apart from the apparatus at a distance corresponding to the stroke of the second arm for transferring the injection-molding product which has been extracted from the injection-molding machine; and a roll-over machine for taking the injection-molding product from the suction plate and putting down the product on the conveyor.

The ratio of the diameter of the first pulley to that of the second pulley is 2:1, and the first arm further comprises a tension idle roller installed thereon for maintaining a constant tension in the transmission belt.

These and other features and advantages of the present invention will be apparent from the following detailed description, in conjunction with the accompanying drawings and appended claims.

### BRIEF DESCRIPTION OF THE DRAWINGS

The benefits and advantages of the present invention will become more readily apparent to those of ordinary skill in the relevant art after reviewing the following detailed description and accompanying drawing. wherein:

FIG. 1 is a front sectional view of an apparatus for extracting an injection-molding product in accordance with an embodiment of the invention;

FIG. 2 is a side sectional view of the apparatus for extracting an injection-molding product shown in FIG. 1;

FIG. 3 is an operational view of the apparatus for extracting an injection-molding product shown in FIG. 1;

FIG. 4 is a schematic view of a suction plate in accordance with the invention;

FIG. 5 is an operational view of a roll-over machine in accordance with the invention;

FIG. 6 is an operational view of a system for extracting an injection-molding product in accordance with an embodiment of the invention;

FIG. 7 is an operational perspective view of prior art first and second arms;

FIG. 8 is an operational perspective view of a prior art system for extracting an injection-molding product; and

FIG. 9 is an operational view of another prior art system for extracting an injection-molding product.

### DETAILED DESCRIPTION OF THE PREFERRED EMBODIMENT

While the present invention is susceptible of embodiment in various forms, there is shown in the drawings and will hereinafter be described a presently preferred embodiment with the understanding that the present disclosure is to be considered an exemplification of the invention and is not intend to limit the invention to the specific embodiment illustrated.

It should be further understood that the title of this section of this specification, namely, “Detailed Description of the Invention”, relates to a requirement of the United States Patent Office, and does not imply, nor should be inferred to limit the subject matter disclosed herein.

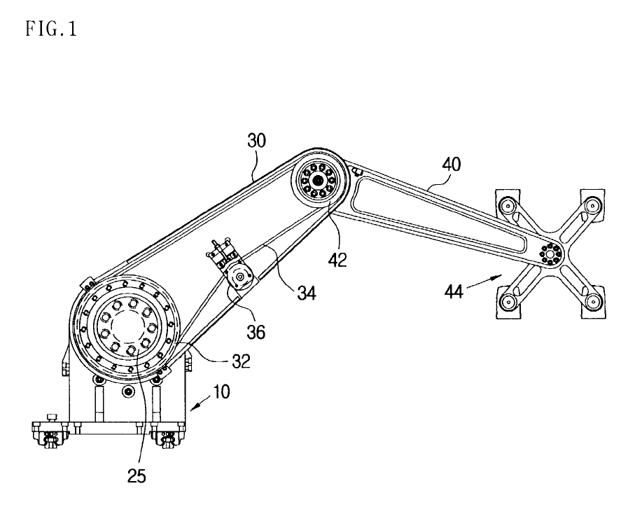

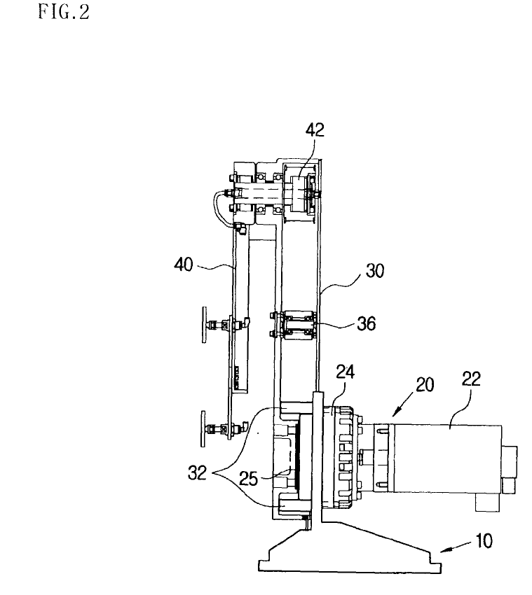

FIGS. 1 and 2 are a front sectional view and a side sectional view, respectively, of an apparatus for extracting an injection-molding product in accordance with an embodiment of the present invention.

As shown in FIGS. 1 and 2, the apparatus for extracting an injection-molding product of the invention comprises a support frame 10, a drive 20, a first arm 30, a second arm 40, a first pulley 32, a second pulley 42, and a transmission belt 34.

The support frame 10 is the part for supporting the drive 20 and the first arm 30, and the drive 20 is installed through the support frame 10.

The drive 20 comprises a drive motor 22 for generating rotation and a reduction gear 24 coupled to the drive motor 22.

The drive motor 22 used is reversible, for example, a rotary cylinder or the like can be used. The drive motor 22 used is preferably an AC servo motor. The AC servo motor is a motor as an actuator used in an AC servo system, in which utility power is first rectified and then transformed into AC again to be used to control an AC motor. The AC servo motor is efficient in maintenance since the AC servo motor has no mechanical part such as a commutator, brush, etc., unlike DC servo motor. In addition, since AC servo motor can be controlled precisely in position and produces high torque, the AC servo motor is preferably used as the drive motor 22 of the invention.

The reduction gear 24, which is a component coupled to an output shaft of the drive motor 22 to increase drive torque of the drive motor 22 by reducing the rotational speed thereof, is insertingly installed directly into the support frame 10. A reduction gear drive plate 25 is coupled to an output end of the reduction gear 24, and a first arm 30 is connected to the reduction gear drive plate 25. Accordingly, the first arm 30 pivots in accordance with the rotational direction of the reduction gear drive plate 25.

A pulley, formed as a wheel around which a belt moves to rotate the wheel, is a mechanical element capable of great power transmission without noise or slippage.

The first pulley 32 is fixedly installed to the support frame 10, especially installed coaxially with the axis of rotation of the first arm 30.

The first pulley 32 is inserted into and fastened to an end of the first arm 30.

The transmission belt 34 is installed to connect the first pulley 32 and the second pulley 42. Accordingly, as the first arm 30 pivots counterclockwise, the transmission belt 34 varies in its portion of contact around the first pulley 32 (which is fixed to the support frame 10), which in turn rotates the second pulley 42 clockwise. The direction of such rotation of the second pulley 42 is opposite to the pivotal direction of the first arm 30.

For the transmission belt 34, a timing belt is preferably used. The timing belt is a toothed transmission belt configured by taking advantages of both a V-belt and a gear, and has no slippage between the belt and the driving/driven wheel and little noise during operation. In addition, the timing belt is easy to repair, has no need for extra lubrication and can transmit great power with its small size.

Alternatively, for the transmission belt, a chain or the like can be used instead.

In order to maintain proper tension in the belt during power transmission, a tension idle roller 36 can be installed at one side of the transmission belt 34, midway between the first and second pulleys 32 and 42.

The second pulley 42 is connected to the first pulley 32 via the transmission belt 34, and rotatably coupled to the other end of the first arm 30.

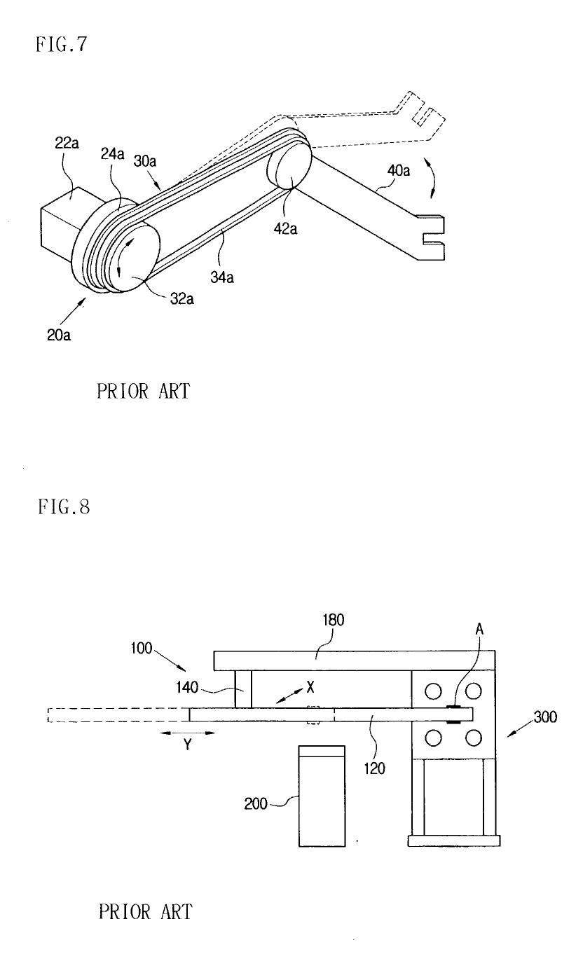

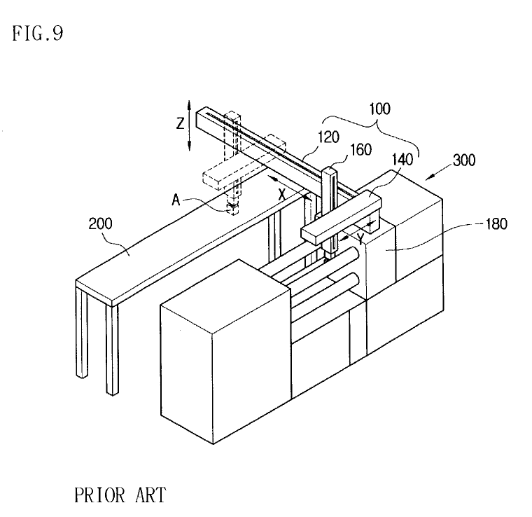

The principle of interlocking between the first and second arms 30 and 40 through a normal transmission belt is as follows. FIG. 7 is an operational perspective view of first and second arms of the prior art construction.

As shown in FIG. 7, in the prior art construction, a first pulley 32a is coupled to a drive 20a, and a second pulley 42a is coupled to the first and second arms 30a and 40a.

A transmission belt 34a transmits the rotation of the first pulley 32a to the second pulley 42a. Accordingly, the first pulley 32a rotates in accordance with the direction of rotation of the drive 20a, and then the second pulley 42a rotates in the same direction as the rotation of the first pulley 32a. As a result, the first and second arms 30a and 40a interlocked with the first and second pulley 32a and 42a pivot in the same direction.

As a result, when the first and second pulleys 32a and 42a and the first and second arms 30a and 40a rotate in the same direction, a greater space and time is required to extract an injection-molding product from an injection-molding machine.

Therefore, the present invention is designed to overcome such drawbacks as described above.

The operational principle of the apparatus for extracting an injection-molding product in accordance with the invention will be described, hereinafter.

Since the first pulley 32 is inserted into the first arm 30 and fixed to the support frame 10, spaced apart from the reduction gear 24, the first pulley 32 is independent of the rotation of the reduction gear 24.

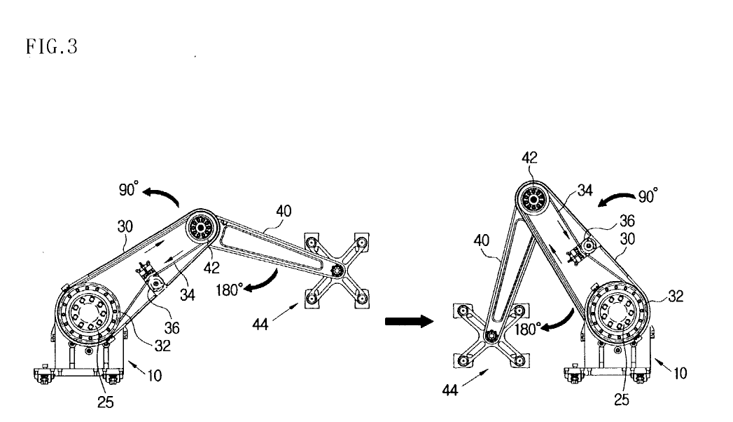

FIG. 3 is an operational view of the apparatus for extracting an injection-molding product in accordance with the invention. As shown in FIG. 3, the transmission belt 34 connected to the first fixed pulley 32 moves clockwise (hereinafter, it is called a reverse direction) as the first arm 30 pivots counter-clockwise (hereinafter, it is called a forward direction), and at the same time, the second pulley 42 connected to the transmission belt 34 also moves in the reverse direction, which in turn causes the second arm 40 connected to the second pulley 42 to pivot in the reverse direction.

In addition, since the ratio of the diameter of the first pulley 32 to that of the second pulley 42 is 2:1, the ratio of the pivotal angle of the first arm 30 to that of the second arm 40 becomes 1:2.

Therefore, since the second arm 40 pivots an amount of 180° in the reverse direction when the first arm 30 is caused to pivot an amount of 90° in the forward direction, it is possible to transfer the injection-molding product A on the conveyor with one-axis rotation.

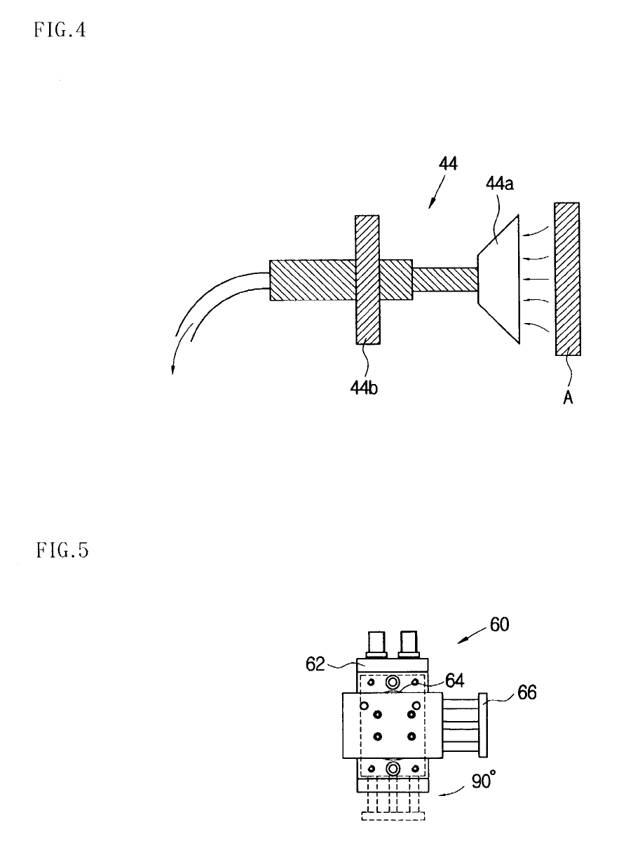

FIG. 4 is a schematic view of the suction plate 44 of the invention, on which a suction pad 44a is installed at an end.

The suction plate 44 is used to suck an injection-molding product in an injection-molding machine. In operation, the suction plate 44 sucks the injection-molding product in the injection-molding machine with its suction pad 44a in vacuum, and releases the suction of the injection-molding product after transferring the injection-molding product onto the conveyor.

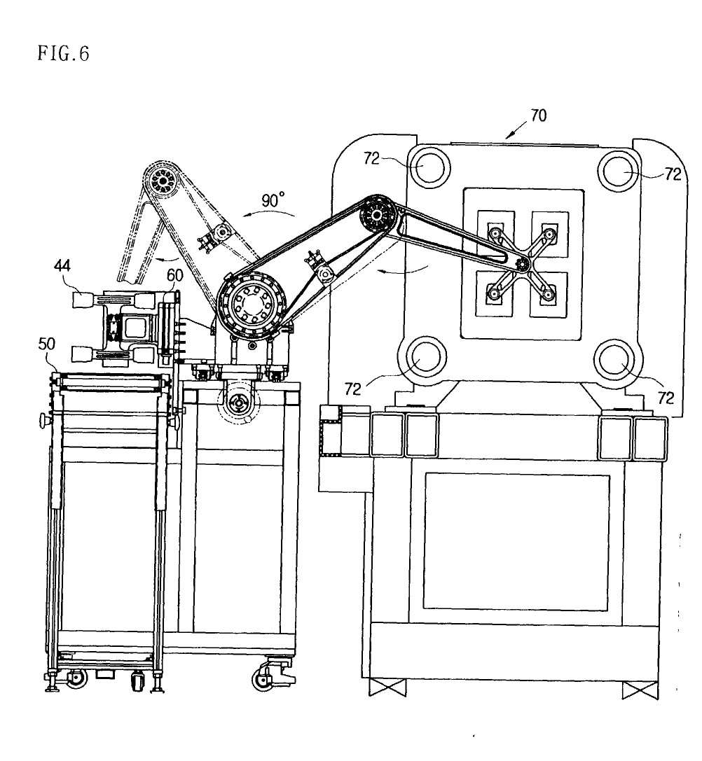

FIG. 6 is an operational view of a system for extracting an injection-molding product in accordance with an embodiment of the invention.

As shown in FIG. 6, the system for extracting an injection-molding product of the invention comprises a conveyor 50, and a roll-over machine 60, in addition to an apparatus for extracting an injection-molding product which comprises a support frame 10, a drive 20, a first arm 30, a second arm 40, a first pulley 32, a second pulley 42 and a transmission belt 34.

The apparatus for extracting an injection-molding product is of the same configuration as shown in FIG. 1, and a common conveyor is used for the conveyor 50.

The roll-over machine 60 is used to take the injection-molding product A from the suction plate 44 and put down on the conveyor 50, and comprises a base 62, rotary part 64, and a roll-over machine suction pad 66.

FIG. 5 is an operational view of the roll-over machine 60 of the invention. The roll-over machine suction pad 66 takes the injection-molding product A from the suction plate 44 and puts down the product A on the conveyor 50 after the rotation of a predetermined angle of the rotary part 64 coupled to the base 62.

That is, after a product A is injection-molded in the injection-molding machine 70, the first arm 30 is caused to pivot an amount of 90° in the reverse direction as the drive 20 rotates in the reverse direction, and then the transmission belt 34 and the second pulley 42 rotates in the forward direction. As a result, the second arm 40 pivots an amount of 180° in the forward direction opposite to the pivotal direction of the first arm 30 so as to move toward the injection-molding machine 70.

The suction plate 44 installed at the second arm 40 which has moved toward the injection-molding machine 70 operates to suck the injection-molding product A from the injection-molding machine 70. Subsequently, the drive 20 rotates in the forward direction so as to pivot the first arm 30 an amount of 90° in the forward direction, thereby causing the transmission belt 34 and the second pulley 42 rotates in the reverse direction. As a result, the second arm 40 pivots an amount of 180° in the reverse direction opposite to the pivotal direction of the first arm 30 so as to move toward the conveyor 50.

The roll-over machine 60 takes the injection-molding product A from the suction plate 44 of the second arm 40 which has moved toward the conveyor 50, rotates in a predetermined angle, and puts down the injection-molding product A on the conveyor 50 safely.

It took 3˜4 seconds to extract an injection-molding product in the conventional apparatus for extracting an injection-molding product driven by a pneumatic-cylinder, and 1.2 to 1.6 seconds in the apparatus driven by an AC servo motor.

However, it is possible to reduce the time required to extract an injection-molding product down to 0.4 seconds in the apparatus in accordance with the present invention.

As described above, the present invention configured to operate in a single-axis rotation provides an apparatus for extracting an injection-molding product, which makes it possible to extract an injection-molding product in a very short time from the injection-molding machine.

As such, the production per hour can be increased and the manufacturing cost can be reduced, which in turn yields an economic apparatus for extracting an injection-molding product.

In addition, since the apparatus for extracting an injection-molding product of the invention operates in rotational motion, the apparatus can be used in a small space, and a worker or an operator is safe without any danger of injury due to the limited strokes of the arms.

Furthermore, it is possible to rotate the second pulley with a simple structure, without any additional motor inserted into the second pulley or any use of gears or the like.

Therefore, the cost of manufacturing for the apparatus can be reduced due to its simple mechanical structure, and an apparatus with less malfunction and sturdy structure is provided because there is no need for any additional devices.

From the foregoing description, it will be observed that various modifications and changes can be made without departing from the true sprit and scope of the present invention. It should be understood that the detailed description and specific examples are given by way of illustration only, and no limitation with respect to the specific embodiments illustrated is intended or should be inferred. The disclosure is intended to cover by the appended claims all such modifications as fall within the scope of the claims.

What is claimed is:

1. An apparatus for extracting an injection-molding product from an injection-molding machine comprising:
a support frame;
a drive installed through the support frame for generating rotation;
a first arm connected to the drive and pivotable according to the rotation of the drive;
a first pulley fixedly installed to the support frame to be inserted into an end of the first arm;
a second pulley connected to the first pulley via a transmission belt and rotatably coupled to the other end of the first arm; and
a second arm connected to the second pulley and pivotable opposite to the pivotal direction of the first arm when the first arm pivots.

2. The apparatus as claimed in claim 1, wherein the ratio of the diameter of the first pulley to that of the second pulley is 2:1.

3. The apparatus as claimed in claim 1, wherein the first arm further comprises a tension idle roller installed thereon for maintaining a constant tension in the transmission belt.

4. The apparatus as claimed in one of the claim 1 to 3, wherein an end of the second arm is provided with a suction plate installed thereon for extracting an injection-molding product from an injection-molding machine through vacuum suction.

5. A system for extracting an injection-molding product from an injection-molding machine comprising:
an apparatus for extracting an injection-molding product comprising:
a drive installed through a support frame for generating rotation;
a first arm connected to the drive and pivotable according to the rotation of the drive;
a first pulley fixedly installed to the support frame to be inserted into an end of the first arm;
a second pulley connected to the first pulley via a transmission belt and rotatably coupled to the other end of the first arm;
a second arm connected to the second pulley and pivotable opposite to the pivotal direction of the first arm when the first arm pivots; and
a suction plate installed at an end of the second arm for extracting an injection-molding product from an injection-molding machine;
a conveyor installed apart from the apparatus at a distance corresponding to the stroke of the second arm for transferring the injection-molding product which has been extracted from the injection-molding machine; and
a roll-over machine for taking the injection-molding product from the suction plate and putting down the product on the conveyor.

6. The system as claimed in claim 5, wherein the ratio of the diameter of the first pulley to that of the second pulley is 2:1.
